(19) United States
(12) Patent Application Publication
(10) Pub. No.: US 2018/0091821 A1
(43) Pub. Date: Mar. 29, 2018

(54) IMAGE PROCESSING APPARATUS AND CONTROLLING METHOD THEREOF

(71) Applicant: SAMSUNG ELECTRONICS CO., LTD., Suwon-si (KR)

(72) Inventor: Seung Ho JEON, Bucheon-si (KR)

(73) Assignee: SAMSUNG ELECTRONICS CO., LTD., Suwon-si (KR)

(21) Appl. No.: 15/692,284

(22) Filed: Aug. 31, 2017

(30) Foreign Application Priority Data
Sep. 26, 2016 (KR) 10-2016-0122934

(51) Int. Cl. H04N 19/187; G06T 3/00; H04N 19/30; H04N 19/61; H04N 19/70

(52) U.S. Cl. CPC H04N 19/187; G06T 3/0062; H04N 19/70; H04N 19/61; H04N 19/30

(57) ABSTRACT

An image processing apparatus includes a decoder that receives a first bit stream and a second bit stream that are encoded according to scalable video coding (SVC), wherein the decoder selects one of the first bit stream and the second bit stream and decodes an enhancement layer included in the selected bit stream to generate an image.

### CROSS-REFERENCE TO RELATED APPLICATION(S)

This application claims priority from Korean patent application 10-2016-0122934, filed on Sep. 26, 2016 in the Korean Intellectual Property Office, the entire disclosure of which is incorporated herein by reference in its entirety.

### BACKGROUND

### 1. Field

Apparatuses and methods consistent with example embodiments relate to an image processing apparatus for receiving a video image from a plurality of camera devices and a controlling method of the image processing apparatus.

### 2. Description of the Related Art

As various types of electronic devices have been introduced and various types of network environments have been provided, a multimedia environment in which various contents are consumable has been established.

Various types of images have been adaptively supplied to the multimedia environment and ultra high definition (UHD) images of four-time resolution or more of high definition (HD) as well as full high definition (FHD) images have been supplied as high resolution and high quality images have been actively supplied. To transmit high resolution and high quality images to various types of electronic devices adaptively to a network environment, technologies for effectively encoding and decoding video have been actively developed. Recently, virtual reality technologies have been applied to electronic devices to allow users to indirectly experience a particular environment or situation that is similar to reality. In particular, a device such as a head mounted display (HMD) provides a see-closed type of image to allow users to visually experience a particular environment.

### SUMMARY

Example embodiments address and/or overcome the above needs, problems and/or disadvantages and other needs, problems and/or disadvantages not described above. Also, an example embodiment is not required to address and/or overcome the needs, problems and/or disadvantages described above, and an example embodiment may not address or overcome any of the needs, problems and/or disadvantages described above.

To process information transmitted from various source devices, high computing ability is required and there is a limit in processing a large amount of information in a limited resource and, thus, there is may be a need for a technology for compressing received information or selectively processing the information.

To receive a high resolution and high quality image from various sources and to selectively provide an image according to user requirements, there is may be a need to appropriately encode and decode the received image.

Example embodiments provide an image processing apparatus and a method of controlling the same, for receiving a video image from various camera devices and providing an image according to user requirements.

According to an aspect of an example embodiment, there is provided an image processing apparatus including: a decoder configured to: decode a first bit stream and a second bit stream that are encoded according to scalable video coding (SVC); and select one from among the first bit stream and the second bit stream; and decode an enhancement layer included in the selected one from among the first bit stream and the second bit stream to generate an image.

The enhancement layer may include a first enhancement layer and a second enhancement layer, and the first bit stream may include a first base layer and the first enhancement layer, and the second bit stream may include a second base layer and the second enhancement layer, and the decoder may be further configured to decode the first base layer, the second base layer, and the enhancement layer included in the selected one from among the first bit stream and the second bit stream.

The decoder may be further configured to decode the first enhancement layer by using the first base layer in response to the first bit stream being selected, and decode the second enhancement layer by using the second base layer in response to the second bit stream being selected.

The SVC may be scalable high efficiency video coding (SHVC).

The decoder may be further configured to select the one from among the first bit stream and the second bit stream corresponding to an input signal from the first bit stream and the second bit stream that is based on a user input.

The input signal may be received from a display device that receives the user input; and the decoder may be configured to transmit the generated image to the display device.

The first bit stream may be an image captured by a first camera device configured to capture an omnidirectional image, and the second bit stream may be an image captured by a second camera device configured to capture an omnidirectional image.

The first bit stream may include an omnidirectional image captured at a first position by the first camera device; and the second bit stream may include an omnidirectional image captured at a second position by the second camera device.

The image processing apparatus may include an image processor configured to stitch the generated image to generate a planar omnidirectional image; and a communication interface configured to transmit the planar omnidirectional image to an external electronic device.

The image processing apparatus may include an image processor configured to stitch the generated image to generate a spherical-surface omnidirectional image; and a display configured to display at least a portion of the spherical-surface omnidirectional image.

According to an aspect of an example embodiment, there is provided a method of controlling an image processing apparatus, the method including: receiving a first bit stream and a second bit stream that are encoded according to scalable video coding (SVC); selecting one from among the first bit stream and the second bit stream; and decoding an enhancement layer of the selected one from among the first bit stream and the second bit stream to generate an image.

The method may further include decoding base layers of the first bit stream and the second bit stream.

The decoding of the enhancement layer of the selected one from among the first bit stream and the second bit stream may include decoding the enhancement layer by using a base layer of the selected one from among the first bit stream and the second bit stream.

The SVC may be scalable high efficiency video coding (SHVC).

The method may further include receiving an input signal, and the selecting the one from among the first bit stream and the second bit stream may include selecting a bit stream corresponding to the input signal in response to receiving the input signal.

The method may further include transmitting the generated image to a display device, and the receiving the input signal may include receiving the input signal from the display device.

The receiving the first bit stream and the second bit stream may include: receiving the first bit stream from a first camera device that generates an omnidirectional image; and receiving the second bit stream from a second camera device that generates an omnidirectional image.

The receiving the first bit stream may include receiving an omnidirectional image captured at a first position by the first camera device; and the receiving the second bit stream may include receiving an omnidirectional image captured at a second position by the second camera device.

The method may further include stitching the generated image to generate a planar omnidirectional image; and transmitting the planar omnidirectional image to an external electronic device.

The method may further include stitching the generated image to generate a spherical-surface omnidirectional image; and displaying at least a portion of the spherical-surface omnidirectional image on a display device.

### BRIEF DESCRIPTION OF THE DRAWINGS

The above and/or other aspects will be more apparent from the following description of example embodiments taken in conjunction with the accompanying drawings, in which:

FIG. 1 is a block diagram of an image processing system according to an example embodiment;

FIG. 2 is a diagram showing an image transmitting method using scalable video coding (SVC) according to an example embodiment;

FIG. 3 is a block diagram of an encoder according to an example embodiment;

FIG. 4 is a block diagram of a decoder according to an example embodiment;

FIG. 5 is a diagram showing decoding of a received bit stream according to an example embodiment;

FIG. 6 is a diagram showing a decoding margin of an image processing apparatus in a portion “A” of FIG. 5, according to an example embodiment;

FIG. 7 is a diagram illustrating a virtual reality system according to an example embodiment; and

FIG. 8 is a flowchart of an image processing method according to an example embodiment.

### DETAILED DESCRIPTION

Example embodiments will be described more fully with reference to the accompanying drawings. However, this is not intended to limit the present disclosure to particular modes of practice, and it is to be appreciated that all modification, equivalents, and alternatives that do not depart from the spirit and technical scope of the present disclosure are encompassed in the present disclosure. With regard to the description of the drawings, the same reference numerals denote like elements.

In this disclosure, the expressions “have”, “may have”, “include” and ^{“}comprise”, or “may include” and “may comprise” used herein indicate existence of corresponding features (e.g., elements such as numeric values, functions, operations, or components) but do not exclude presence of additional features.

In this disclosure, the expressions “A or B”, “at least one of A or/and B”, or ^{“}one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in this disclosure may be used to refer to various elements regardless of the order and/or the priority and to distinguish the relevant elements from other elements, but do not limit the elements. For example, “a first user device” and “a second user device” indicate different user devices regardless of the order or priority. For example, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used in this disclosure may be used as, for example, the expression “suitable for”, “having the capacity to”, “designed to”, “adapted to”, “made to”, or “capable of”. The term “configured to” does not necessarily mean “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in this disclosure are used to describe example embodiments and are not intended to limit the scope of another example embodiment. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various example embodiments. In some cases, even if terms are terms which are defined in this disclosure, they may not be interpreted to exclude example embodiments.

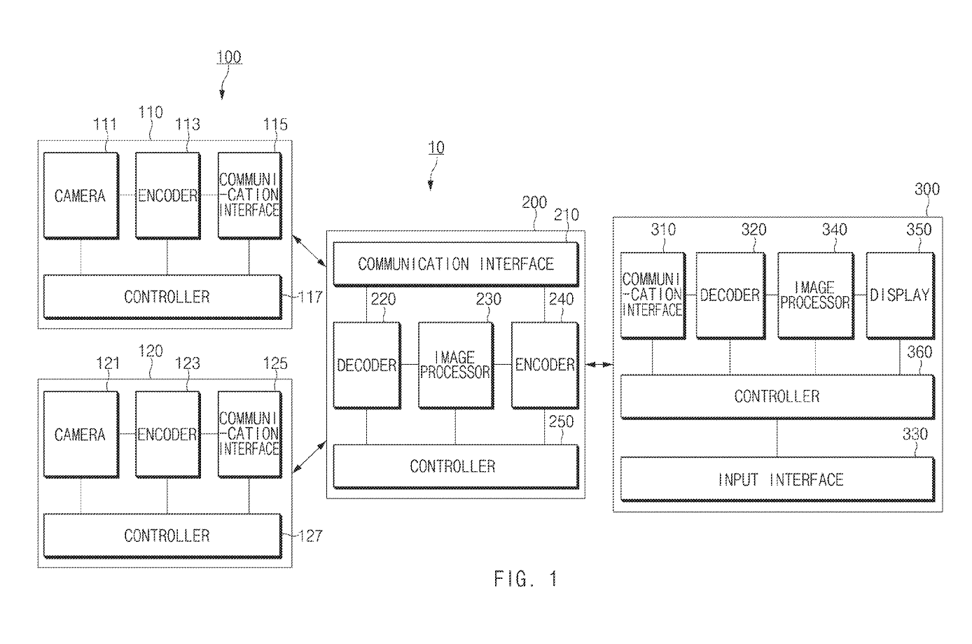

FIG. 1 is a block diagram of an image processing system according to an example embodiment.

Referring to FIG. 1, an image processing system 10 may include a photographing apparatus 100, an image processing apparatus 200, and a display apparatus 300.

The photographing apparatus 100 may include a first camera device 110 and a second camera device 120. For example, the photographing apparatus 100 may include two or more camera devices.

The first camera device 110 may include a camera 111, an encoder 113, a communication interface 115, and a controller 117.

According to an example embodiment, the camera 111 may capture an image. For example, the camera 111 may capture an omnidirectional image with respect to the first camera device 110. The omnidirectional image may be, for example, an image obtained by dividing and photographing an object at a specified angle. The omnidirectional image may be displayed on the display apparatus 300 through the image processing apparatus 200 to implement virtual reality. According to an example embodiment, the camera 111 may consecutively capture an image to capture a video image. For example, the image captured by the camera 111 may be a frame of the video image.

According to an example embodiment, the encoder 113 may encode a video image according to scalable video coding (SVC) to generate a single bit stream with hierarchy. The SVC may be, for example, scale high efficiency video coding (SHVC) that is scalable extension of high efficiency video coding (HEVC). For example, the encoder 113 may encode a video image according to the SHVC to generate a bit stream.

According to an example embodiment, the bit stream generated by the encoder 113 may include a base layer and an enhancement layer. The enhancement layer may include a plurality of layers depending on resolution. The encoder 113 may encode the enhancement layer with reference to the base layer. The base layer and the enhancement layer may each include, for example, image information corresponding to a frame of a video image.

According to an example embodiment, the communication interface 115 may be connected to the image processing apparatus 200 and may transmit the bit stream. For example, the communication interface 115 may be a wired communication interface. The communication interface 115 may be connected to the image processing apparatus 200 through a cable and may transmit the bit stream to the image processing apparatus 200. As another example, the communication interface 115 may be a wireless communication interface. The communication interface 115 may be wirelessly connected to the image processing apparatus 200 and may transmit the bit stream to the image processing apparatus 200.

According to an example embodiment, the controller 117 may control an overall operation of the first camera device 110. The controller 117 may control the camera 111 to capture a video image. The controller 117 may control the encoder 113 to encode the video image according to SVC to generate a bit stream. The controller 117 may control the communication interface 115 to transmit the bit stream to the image processing apparatus 200.

The second camera device 120 may include a camera 121, an encoder 123, a communication interface 125, and a controller 127. The second camera device 120 may be similar to the first camera device 110. The camera 121, the encoder 123, the communication interface 125, and the controller 127 of the second camera device 120 may be similar to the camera 111, the encoder 113, the communication interface 115, and the controller 117 of the first camera device 110. According to an example embodiment, the second camera device 120 may capture a video image, may encode the video image according to SVC to generate a bit stream, and may transmit the bit stream to the image processing apparatus 200.

Accordingly, each of the first camera device 110 and the second camera device 120 of the photographing apparatus 100 may generate a bit stream and may transmit the bit stream to the image processing apparatus 200.

The image processing apparatus 200 may include a communication interface 210 (e.g., communication interface), a decoder 220, an image processor 230 (e.g., image processor), an encoder 240, and a controller 250.

The communication interface 210 may be connected to the first camera device 110, the second camera device 120, and the display apparatus 300 to transmit and receive a signal. For example, the communication interface 210 may be a wired communication interface and the communication interface 210 may be connected to the first camera device 110, the second camera device 120, and the display apparatus 300 through a cable and may transmit and receive a signal. As another example, the communication interface 210 may be a wireless communication interface and may be wirelessly connected to the first camera device 110, the second camera device 120, and the display apparatus 300 to wirelessly transmit and receive a signal.

According to an example embodiment, the communication interface 210 may be connected to the first camera device 110 and the second camera device 120 and may receive each bit stream from the first camera device 110 and the second camera device 120.

According to an example embodiment, the communication interface 210 may be connected to the display apparatus 300 and may transmit and receive a signal. For example, the communication interface 210 may transmit the bit stream received from the encoder 240 to the display apparatus 300. The communication interface 210 may receive an input signal from the display apparatus 300. The input signal may be, for example, a signal corresponding to user input that is input through the display apparatus 300.

The decoder 220 may decode the encoded video image according to SVC to generate a video image. The decoder 220 may decode a base layer and an enhancement layer of the bit stream received from the photographing apparatus 100 to generate a video image. The enhancement layer may be decoded with reference to the base layer. For example, the decoder 220 may decode a bit stream according to SHVC to generate a video image.

According to an example embodiment, the decoder 220 may select one of a bit stream of the first camera device 110 and a bit stream of the second camera device 120 to generate a video image. For example, the decoder 220 may receive an input signal for selection of a bit stream from the display apparatus 300 and may select a bit stream signal. The decoder 220 may decode an enhancement layer of the one selected bit stream to generate a video image with reference to a base layer of the one selected bit stream.

The image processor 230 may process the generated video image to be displayed on a display. The video image may include, for example, an omnidirectional image obtained by dividing and photographing an object. According to an example embodiment, the image processor 230 may stitch boundaries of the omnidirectional image obtained by dividing and photographing an object. For example, the image processor 230 may connect boundaries of the image obtained by dividing and photographing an object to generate a two-dimensional planar omnidirectional image. For example, the planar omnidirectional image may be transmitted to the display apparatus 300, changed to a spherical-surface omnidirectional image positioned on a spherical surface, and displayed on a display. As another example, the image processor 230 may connect boundaries of images formed by dividing and photographing an object to generate the planar omnidirectional image, may change the planar omnidirectional image to the spherical-surface omnidirectional image, and may display at least a portion of the spherical-surface omnidirectional image on the display. For example, the display may be a display included in the image processing apparatus 200.

The encoder 240 may encode the video image generated through the image processor 230 to generate a bit stream. For example, the encoder 240 may encode a video image to be non-scalable according to Divx (e.g., Divx3.x, Divx4, and Divx5), Xvid, MPEG (e.g., MPEG1, MPEG2, and MPEG4), H.264, VP9, HEVC, and so on.

The controller 250 may control an overall operation of the image processing apparatus 200. The controller 250 may control the communication interface 210 to receive respective bit streams from the first camera device 110 and the second camera device 120. The controller 250 may control the decoder 220 to select a bit stream corresponding to a received input signal among the bit streams received from the first camera device 110 and the second camera device 120 and decode the selected bit stream according to SVC. The controller 250 may control the image processor 230 to process a video image of the decoded bit stream to be displayed on a display. The controller 250 may control the encoder 240 to encode the video image. The controller 250 may control the communication interface 210 to transmit the bit stream of the encoded video image to the display apparatus 300.

Accordingly, the image processing apparatus 200 may select one of the respective bit streams received from the first camera device 110 and the second camera device 120 to generate a video image and may transmit the generated video image to the display apparatus 300.

The display apparatus 300 may include a communication interface 310, a decoder 320, an input interface 330, an image processor 340, a display 350, and a controller 360.

The communication interface 310 may be connected to the image processing apparatus 200 and may transmit and receive a signal. For example, the communication interface 310 may be a wired communication interface and the communication interface 310 may be connected to the image processing apparatus 200 through a cable and may transmit and receive a signal. As another example, the communication interface 310 may be a wireless communication interface and the communication interface 310 may be wirelessly connected to the image processing apparatus 200 and may transmit and receive a signal.

According to an example embodiment, the communication interface 310 may be connected to the image processing apparatus 200 and may receive a bit stream from the image processing apparatus 200.

According to an example embodiment, the communication interface 310 may transmit an input signal generated by the controller 360. For example, the controller 360 may generate an input signal corresponding to user input that is input through the input interface 330 and may transmit the input signal to the image processing apparatus 200 through the communication interface 310.

The decoder 320 may decode the received bit stream to generate a video image. The decoder 320 may decode the bit stream to generate a video image. For example, the decoder 320 may decode the bit stream according to Divx (e.g., Divx3.x, Divx4, and Divx5), Xvid, MPEG (e.g., MPEG1, MPEG2, and MPEG4), H.264, VP9, HEVC, and so on to generate a video image.

The input interface 330 may receive input from a user and transmit the input to the controller 360. The controller 360 may receive the input and generate an input signal corresponding to the input. According to an example embodiment, the input interface 330 may generate an input signal for selection of a bit stream selected by the image processing apparatus 200. For example, the user may input the bit stream selected by the image processing apparatus 200 through the input interface 330. According to an example embodiment, the input interface 330 may generate an input signal for extracting a video image displayed on the display 350 from the video image including the omnidirectional image generated by the decoder 320. For example, the input interface 330 may detect a movement direction of the user and may generate an input signal for extracting a video image corresponding to the movement direction of the user.

The image processor 340 may process the generated video image to be displayed on a display. The video image may include, for example, a planar omnidirectional image. According to an example embodiment, the image processor 340 may change the planar omnidirectional image to a spherical-surface omnidirectional image. According to an example embodiment, the image processor 340 may extract and generate a display image corresponding to the input signal of the user from the spherical-surface omnidirectional image. The display image may be, for example, at least a portion of the spherical-surface omnidirectional image.

The display 350 may display the display image generated by the image processor 340.

The controller 360 may control an overall operation of the display apparatus 300. The controller 360 may control the communication interface 310 to receive a bit stream from the image processing apparatus 200. The controller 360 may control the decoder 320 to decode the bit stream received from the image processing apparatus 200. The controller 360 may control the input interface 330 to receive user input and may generate an input signal. The controller 360 may control the image processor 340 to process and display the decoded image on a display and extract a portion corresponding to the input signal to generate a display image. The controller 360 may control the display 350 to display the display image on the display 350.

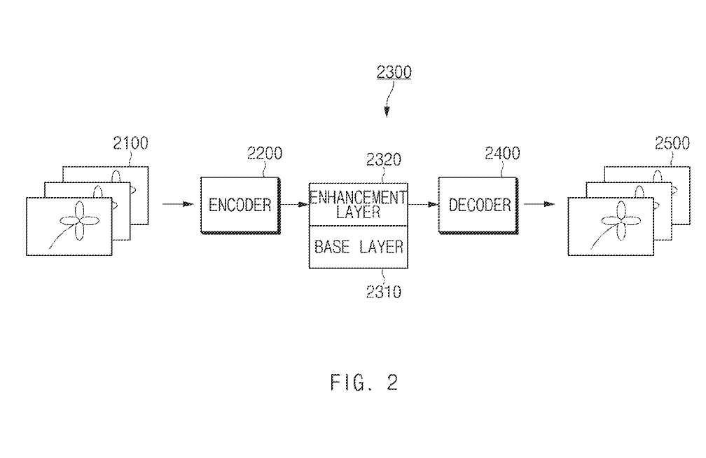

FIG. 2 is a diagram showing an image transmitting method using scalable video coding (SVC) according to an example embodiment.

Referring to FIG. 2, a video image 2100 captured by a camera device may be encoded by an encoder 2200. The encoder 2200 may encode the video image 2100 according to SVC to generate a bit stream 2300. The bit stream 2300 may include, for example, a base layer 2310 and an enhancement layer 2320.

The bit stream 2300 may be decoded by a scalable decoder 2400. The scalable decoder 2400 may decode the bit stream 2300 according to SVC to generate a video image 2500 displayed on a display device.

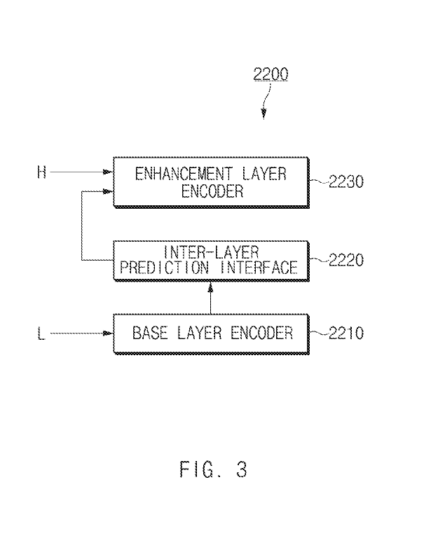

FIG. 3 is a block diagram of an encoder according to an example embodiment.

Referring to FIG. 3, the encoder 2200 may include a base layer encoder 2210, an inter-layer prediction interface 2220, and an enhancement layer encoder 2230. The encoder 2200 may encode a video image according to SVC.

Video images for encoding respective layers may be input to the base layer encoder 2210 and the enhancement layer encoder 2230. A low resolution video image “L” may be input to the base layer encoder 2210 and a high resolution video image “H” may be input to the enhancement layer encoder 2230.

The base layer encoder 2210 may encode the low resolution video image “L” according to SVC to generate the base layer 2310. Information on encoding performed by the base layer encoder 2210 may be transmitted to the inter-layer prediction interface 2220. The encoding information may be information on restored video information with low resolution.

The inter-layer prediction interface 2220 may up-sample the encoding information of the base layer and may transmit the up-sampled information to the enhancement layer encoder 2230.

The enhancement layer encoder 2230 may encode the high resolution video image “H” by using the encoding information transmitted from the inter-layer prediction interface 2220 according to SVC to generate the enhancement layer 2320.

According to an example embodiment, when encoding a frame of a high resolution video image “H”, the enhancement layer encoder 2230 may use information on a frame of the low resolution video image “L”, corresponding to the frame of the high resolution video image “H”.

Accordingly, the encoder 2200 may generate a bit stream including the enhancement layer 2320 generated using the base layer 2310.

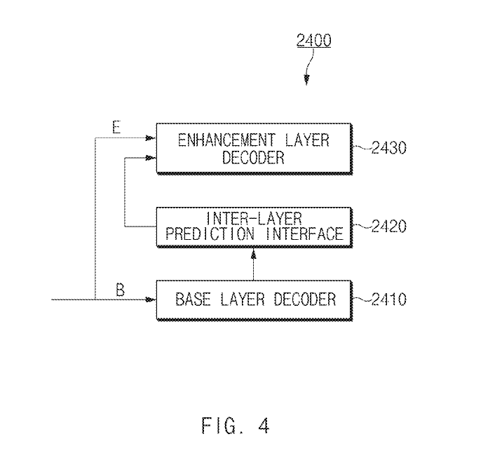

FIG. 4 is a block diagram of a decoder according to an example embodiment.

Referring to FIG. 4, a decoder 2400 may include a base layer decoder 2410, an inter-layer prediction interface 2420, and an enhancement layer decoder 2430. The decoder 2400 may decode a bit stream according to SVC.

The decoder 2400 may receive a bit stream including a base layer “B” and an enhancement layer “E”. The base layer “B” may be input to the base layer decoder 2410 and the enhancement layer “E” may be input to the enhancement layer decoder 2430.

The base layer decoder 2410 may decode the base layer “B” according to SVC. Information on decoding performed by the base layer decoder 2410 may be transmitted to the inter-layer prediction interface 2420. The decoding information may be information on a restored video image with low resolution.

The inter-layer prediction interface 2420 may up-sample encoding information of the base layer “B” and may transmit the up-sampled information to the enhancement layer decoder 2430.

The enhancement layer decoder 2430 may decode the enhancement layer “E” by using the decoding information transmitted from the inter-layer prediction interface 2420 according to SVC to generate a high resolution video image.

According to an example embodiment, when decoding a frame of the high resolution video image, the enhancement layer decoder 2430 may use information on a frame of a low resolution video image, corresponding to the frame of the high resolution video image.

Accordingly, the decoder 2400 may decode the enhancement layer 2320 by using the base layer 2310 to generate a high resolution video image.

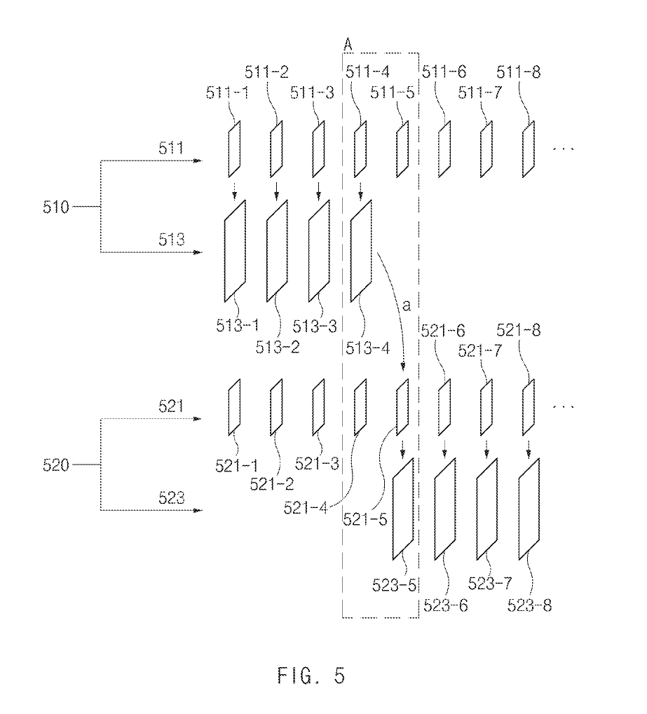

FIG. 5 is a diagram showing decoding of a received bit stream according to an example embodiment.

Referring to FIG. 5, a first bit stream 510 and a second bit stream 520 may be input to the image processing apparatus 200.

When the first bit stream 510 is decoded, a first base layer frame 511 and a first enhancement layer frame 513 may be generated. The first base layer frame 511 may be a frame of a low resolution video image and the first enhancement layer frame 513 may be a frame of a high resolution video image.

When the second bit stream 520 is decoded, a second base layer frame 521 and a second enhancement layer frame 523 may be generated. The second base layer frame 521 may be a frame of a low resolution video image and the second enhancement layer frame 523 may be a frame of a high resolution video image.

When the first bit stream 510 is selected by a user, the image processing apparatus 200 may decode a base layer of the first bit stream 510 and a base layer of the second bit stream 520 to generate the first base layer frame 511 and the second base layer frame 521 and may decode an enhancement layer of the selected first bit stream 510 to generate the first enhancement layer frame 513. The enhancement layer of the first bit stream 510 may be decoded using the first base layer frame 511. The first enhancement layer frame 513 may be generated using the first base layer frame 511 corresponding thereto. For example, a first frame 513-1, a second frame 513-2, a third frame 513-3, and a fourth frame 513-4 of the first enhancement layer frame 513 generated by decoding the enhancement layer of the first bit stream 510 may be generated using a first frame 511-1, a second frame 511-2, a third frame 511-3, and a fourth frame 511-4 of the first base layer frame 511 generated by decoding the base layer of the first bit stream 510, respectively. The base layer of the second bit stream 520 may be decoded to generate a first frame 521-1, a second frame 521-2, a third frame 521-3, and a fourth frame 521-4 of the second base layer frame 521.

In response to change “a” in selection of the second bit stream 520 by the user, the image processing apparatus 200 may decode the base layer of the first bit stream 510 and the base layer of the second bit stream 520 to generate the first base layer frame 511 and the second base layer frame 521 and decode the enhancement layer of the selected second bit stream 520 to generate the second enhancement layer frame 523. The enhancement layer of the second bit stream 520 may be decoded using the second base layer frame 521. The second enhancement layer frame 523 may be generated using the second base layer frame 521 corresponding thereto. For example, a fifth frame 523-5, a sixth frame 523-6, a seventh frame 523-7, and an eighth frame 523-8 of the second enhancement layer frame 523 generated by decoding the enhancement layer of the second bit stream 520 may be generated using a fifth frame 521-5, a sixth frame 521-6, a seventh frame 521-7, and an eighth frame 521-8 of the second base layer frame 521 generated by decoding the base layer of the second bit stream 520, respectively. The base layer of the first bit stream 510 may be decoded to generate a fifth frame 511-5, a sixth frame 511-6, a seventh frame 511-7, and an eighth frame 511-8 of the first base layer frame 511.

According to an example embodiment, to decode only an enhancement layer of a bit stream selected from the first bit stream 510 and the second bit stream 520, the image processing apparatus 200 may continuously decode the base layers of the first bit stream 510 and the second bit stream 520 irrespective of selection.

Accordingly, the image processing apparatus 200 may decode one bit stream selected from the first bit stream 510 and the second bit stream 520 with reference to the base layers of the first bit stream 510 and the second bit stream 520.

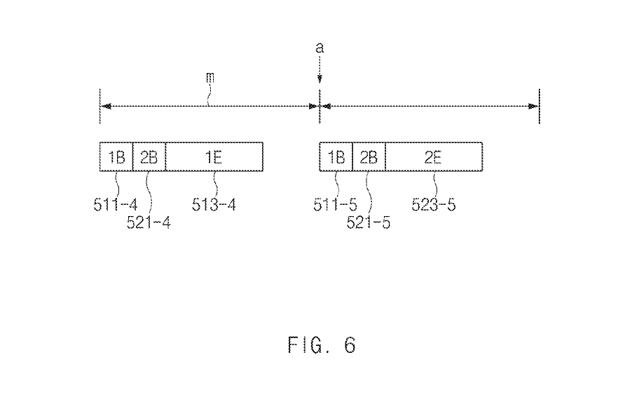

FIG. 6 is a diagram showing a decoding margin of an image processing apparatus in a portion “A” of FIG. 5, according to an example embodiment.

Referring to FIG. 6, one-time decoding capability of the image processing apparatus 200 may be limited and may be denoted by a decoding margin “m”.

In the portion “A” of FIG. 5, the image processing apparatus 200 may decode only the fourth frame 511-4 of the first base layer frame 511, the fourth frame 521-4 of the second base layer frame 521, and the fourth frame 513-4 of the first enhancement layer frame 513 to process the frame in the decoding margin “m” in response to selection of the first bit stream 510 by a user. The image processing apparatus 200 may decode only the fifth frame 511-5 of the first base layer frame 511, the fifth frame 521-5 of the second base layer frame 521, and the fifth frame 523-5 of the second enhancement layer frame 523 to process the frame in the decoding margin “m” in response to change “a” in selection of the second bit stream 520 by the user.

According to an example embodiment, since the first base layer frame 511 and the second base layer frame 521 are low resolution frames, small decoding margins 1B and 2B may be occupied for a decoding operation of the image processing apparatus 200 and, since the first enhancement layer frame 513 and the second enhancement layer frame 523 are high resolution frames, large decoding margins 1E and 2E may be occupied for a decoding operation of the image processing apparatus 200.

Accordingly, the image processing apparatus 200 may decode one enhancement layer selected from the first bit stream 510 and the second bit stream 520 to rapidly process a frame of a video image in the decoding margin “m”.

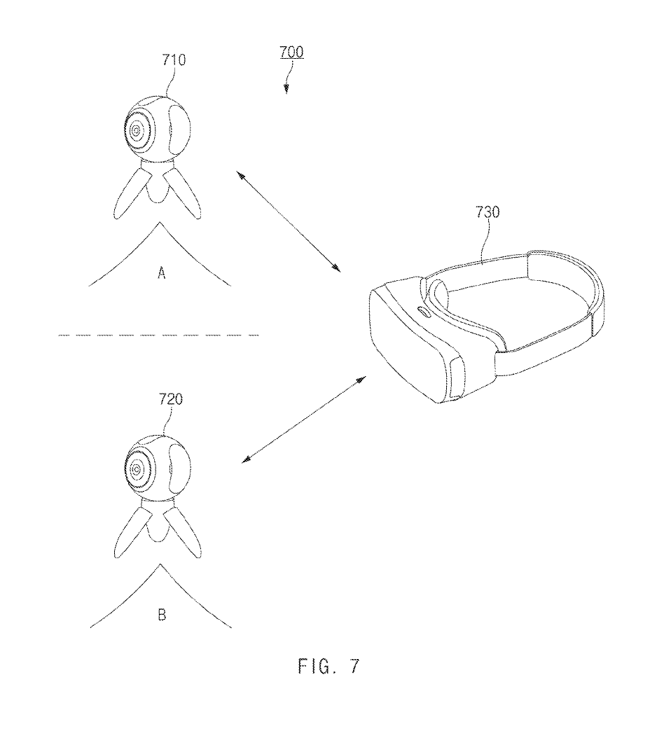

FIG. 7 is a diagram illustrating a virtual reality system according to an example embodiment.

Referring to FIG. 7, a virtual reality system 700 may include a first camera device 710, a second camera device 720, and a display device 730.

The first camera device 710 may capture a video image in a first area “A” and the second camera device 720 may capture a video image in a second area “B”. The first camera device 710 and the second camera device 720 may capture the video images of the first area “A” and the second area “B”, may encode the video images according to SVC to generate the bit streams, and may transmit the respective bit streams to the display device 730.

The display device 730 may have functions of the image processing apparatus 200 and the display apparatus 300 of FIG. 1. For example, the display device 730 may be an element formed by further adding the input interface 330 and the display 350 of the display apparatus 300 to the image processing apparatus 200 of FIG. 1.

According to an example embodiment, when a user inputs information on a desired area through the display device 730, the display device 730 may select a bit stream corresponding to the input from bits streams of the first camera device 710 and the second camera device 720 and may decode an enhancement layer of the selected bit stream to generate a video image.

According to an example embodiment, the display device 730 may detect a movement direction of the user, may extract a video image corresponding to the movement direction of the user from the generated video image, and may display the video image on a display.

Accordingly, the user may experience virtual reality of two areas in response to selection through the display device 730.

According to the various example embodiments described with reference to FIGS. 1 to 7, when receiving and processing a video image captured by a plurality of camera devices, the image processing apparatus 200 may encode the video image according to SVC and may decode only an enhancement layer of a bit stream selected by the user so as to simultaneously process a plurality of bit streams and, when the user selects a desired video image, the image processing apparatus 200 may rapidly display the selected video image on a display.

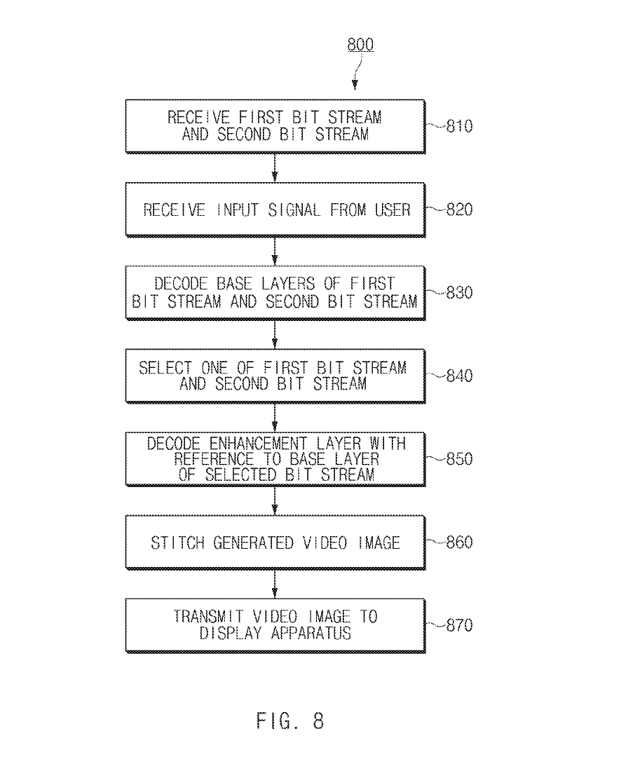

FIG. 8 is a flowchart of an image processing method according to an example embodiment.

The flowchart of FIG. 8 may include operations processed by the aforementioned image processing apparatus 200. Accordingly, although omitted hereinafter, a description of the display apparatus 300 given with reference to FIGS. 1 to 7 may also be applied to the flowchart 800 of FIG. 8.

According to an example embodiment, in operation 810, the image processing apparatus 200 may receive a first bit stream and a second bit stream that are encoded according to SVC from the first camera device 110 and the second camera device 120, respectively. The SVC may encode an image according to scale high efficiency video coding (SHVC) that is scalable extension of high efficiency video coding (HEVC).

According to an example embodiment, in operation 820, the image processing apparatus 200 may receive an input signal from a user. The image processing apparatus 200 may receive the input signal from the display apparatus 300. The user may generate an input signal for selection of one of the first bit stream and the second bit stream through the display apparatus 300.

According to an example embodiment, in operation 830, the image processing apparatus 200 may decode base layers of the first bit stream and the second bit stream. The image processing apparatus 200 may decode the base layers of the first bit stream and the second bit stream irrespective of user selection.

According to an example embodiment, in operation 840, the image processing apparatus 200 may select one of the first bit stream and the second bit stream. Upon receiving the input signal, the image processing apparatus 200 may select a bit stream corresponding to the input signal.

According to an example embodiment, in operation 850, the image processing apparatus 200 may decode an enhancement layer of a selected bit stream with reference to the base layer of the selected bit stream to generate a video image.

According to an example embodiment, in operation 860, the image processing apparatus 200 may stitch the generated video image. When a video image including an omnidirectional image formed by dividing and photographing an object by the first camera device 110 and the second camera device 120 is transmitted to the image processing apparatus 200, the image processing apparatus 200 may stitch the omnidirectional image formed by dividing and photographing the object to generate a planar omnidirectional image.

According to an example embodiment, in operation 870, the image processing apparatus 200 may transmit the video image to the display apparatus 300. The display apparatus 300 may receive the video image and display the video image on the display 350. For example, when a video image includes the planar omnidirectional image, the display apparatus 300 may change the video image to a spherical-surface omnidirectional image positioned on a spherical surface. The display apparatus 300 may extract a display image corresponding to an input signal of a user from the spherical-surface omnidirectional image. The display apparatus 300 may display the display image on the display 350.

In the specification, the term “module” may refer to, for example, a unit including one or two or more combinations of hardware, software, and firmware. The term “module” may be interchangeably used with, for example, terms such as “unit”, “logic”, “logical block”, “component”, or “circuit”. The “module” may refer to a minimum unit of an integrally configured element or a portion thereof. The “module” may refer to a minimum unit for performing one or more functions or a portion thereof. The “module” may be mechanically or electrically implemented. For example, the “module” may include at least one of an application-specific integrated circuit (ASIC) chip, field-programmable gate arrays (FPGAs), and a programmable-logic device for performing some operations, which are well known and will be developed in the future and perform specified operations.

At least some of the apparatuses or the methods (e.g., operations) according to the various example embodiments may be implemented with, for example, a processor and instructions stored in computer-readable storage media. When the instructions are executed by one or more processors, the one or more processors may perform a function corresponding to the instructions. The computer-readable storage media may be, for example, a memory. For example, the encoder, the decoder, the image processor, and/or the controller may be implemented by one or more microprocessors and/or integrated circuits executing instructions stored in computer-readable media.

The computer-readable storage media may include a hard disk, a floppy disk, magnetic media (e.g., a magnetic tape), optical media (e.g., CD-ROM, and digital versatile disk (DVD)), magneto-optical media (e.g., a floptical disk), a hardware device (e.g., ROM, RAM, or flash memory), and so on. In addition, the program commands may include a machine language code created by a compiler and a high-level language code executable by a computer using an interpreter and the like.

According to the various example embodiments, when receiving and processing a video image captured by a plurality of camera devices, an image processing apparatus may encode the video image according to SVC and decode only an enhancement layer of a bit stream selected by a user so as to simultaneously process a plurality of bit streams and, when the user selects a desired video image, the image processing apparatus may rapidly display the selected video image on a display.

In addition, various advantageous effects that are directly or indirectly recognized through the specification may be provided.

While example embodiments have been shown and described, it will be understood by those skilled in the art that various changes in form and details may be made therein without departing from the spirit and scope of the present disclosure as defined by the appended claims and their equivalents.

What is claimed is:

1. An image processing apparatus comprising:
a decoder configured to:
decode a first bit stream and a second bit stream that are encoded according to scalable video coding (SVC),
wherein the decoder is configured to select one of the first bit stream and the second bit stream and to decode an enhancement layer included in the selected bit stream to generate an image.

2. The image processing apparatus of claim 1, wherein the enhancement layer comprises a first enhancement layer and a second enhancement layer,
wherein the first bit stream comprises a first base layer and the first enhancement layer,
wherein the second bit stream comprises a second base layer and the second enhancement layer, and
wherein the decoder is further configured to decode the first base layer, the second base layer.

3. The image processing apparatus of claim 2, wherein the decoder is configured to decode the first enhancement layer by using the first base layer in response to the first bit stream being selected, and decode the second enhancement layer by using the second base layer in response to the second bit stream being selected.

4. The image processing apparatus of claim 1, wherein the SVC is scalable high efficiency video coding (SHVC).

5. The image processing apparatus of claim 1, wherein the decoder is configured to select the one from among the first bit stream and the second bit stream corresponding to an input signal that is based on a user input.

6. The image processing apparatus of claim 5, wherein the input signal is received from a display device that receives the user input; and
wherein the decoder is configured to transmit the generated image to the display device.

7. The image processing apparatus of claim 1, wherein the first bit stream is an image captured by a first camera device configured to capture an omnidirectional image, and
wherein the second bit stream is an image captured by a second camera device configured to capture an omnidirectional image.

8. The image processing apparatus of claim 7, wherein the first bit stream comprises an omnidirectional image captured at a first position by the first camera device; and
the second bit stream comprises an omnidirectional image captured at a second position by the second camera device.

9. The image processing apparatus of claim 1, further comprising:
an image processor configured to stitch the generated image to generate a planar omnidirectional image; and
a communication interface configured to transmit the planar omnidirectional image to an external electronic device.

10. The image processing apparatus of claim 1, further comprising:
an image processor configured to stitch the generated image to generate a spherical-surface omnidirectional image; and
a display configured to display at least a portion of the spherical-surface omnidirectional image.

11. A method of controlling an image processing apparatus, the method comprising:
receiving a first bit stream and a second bit stream that are encoded according to scalable video coding (SVC);
selecting one from among the first bit stream and the second bit stream; and
decoding an enhancement layer of the selected one from among the first bit stream and the second bit stream to generate an image.

12. The method of claim 11, further comprising decoding base layers of the first bit stream and the second bit stream.

13. The method of claim 11, wherein the decoding of the enhancement layer of the selected one from among the first bit stream and the second bit stream comprises decoding the enhancement layer by using a base layer of the selected one from among the first bit stream and the second bit stream.

14. The method of claim 11, wherein the SVC is scalable high efficiency video coding (SHVC).

15. The method of claim 11, further comprising receiving an input signal,
wherein the selecting the one from among the first bit stream and the second bit stream comprises selecting a bit stream corresponding to the input signal in response to receiving the input signal.

16. The method of claim 15, further comprising:
transmitting the generated image to a display device,
wherein the receiving the input signal comprises receiving the input signal from the display device.

17. The method of claim 11, wherein the receiving the first bit stream and the second bit stream comprises:
receiving the first bit stream from a first camera device that generates an omnidirectional image; and
receiving the second bit stream from a second camera device that generates an omnidirectional image.

18. The method of claim 17, wherein the receiving the first bit stream comprises receiving an omnidirectional image captured at a first position by the first camera device; and
wherein the receiving the second bit stream comprises receiving an omnidirectional image captured at a second position by the second camera device.

19. The method of claim 11, further comprising:
stitching the generated image to generate a planar omnidirectional image; and
transmitting the planar omnidirectional image to an external electronic device.

20. The method of claim 11, further comprising:
stitching the generated image to generate a spherical-surface omnidirectional image; and
displaying at least a portion of the spherical-surface omnidirectional image on a display device.
